(19) United States
(12) Patent Application Publication
(10) Pub. No.: US 2025/0148917 A1
(43) Pub. Date: May 8, 2025

(54) DRIVER ASSIST CONTROL DEVICE, DRIVER ASSIST METHOD, AND NONTRANSITORY COMPUTER STORAGE MEDIUM

(71) Applicant: TOYOTA JIDOSHA KABUSHIKI KAISHA, Aichi-ken (JP)

(72) Inventor: Masakazu NISHIJIMA, Ebina-shi (JP)

(21) Appl. No.: 18/934,243

(22) Filed: Nov. 1, 2024

(30) Foreign Application Priority Data
Nov. 8, 2023 (JP) 2023-190902

(51) Int. Cl. G08G 1/16; B60W 30/09; B60W 30/18; B60W 50/12; B60W 50/14

(52) U.S. Cl. CPC G08G 1/167; B60W 30/09; B60W 30/18154; B60W 30/18159; B60W 50/12; B60W 50/14; B60W 2050/143; B60W 2050/146; B60W 2552/53; B60W 2554/406

(57) ABSTRACT

A driver assist control device of a vehicle provided with a surrounding sensor configured to acquire surrounding data showing at least the situation ahead of the vehicle, wherein the driver assist control device is configured to limit driver assist provided before entering or when entering a crosswalk when the time period during which at least part of the crosswalk region ahead on an adjoining lane of a current lane in which the vehicle is running continues to be a blind spot of the surrounding sensor is less than a predetermined time period.

### FIELD

The present disclosure relates to a driver assist control device, driver assist method, and non-transitory computer storage medium.

### BACKGROUND

Japanese Unexamined Patent Publication No. 2022-148428 discloses a conventional driver assist control device reporting when a number of pedestrians at a crosswalk displayed in an image captured by a camera mounted in a host vehicle before a crosswalk differs from the number of pedestrians at the crosswalk displayed in an image captured by an external camera installed near the crosswalk.

### SUMMARY

However, the above-mentioned conventional driver assist control device has the problem that it is not possible to make such a report if an image captured by an external camera cannot be acquired.

The present disclosure was made focusing on such a problem and has as its object to be able to provide suitable driver assist according to the surrounding environment when passing a crosswalk without acquiring an image captured by an external camera.

To solve the above problem, according to one aspect of the present disclosure, there is provided a driver assist control device of a vehicle provided with a surrounding sensor acquiring surrounding data showing at least the situation ahead of the vehicle, which device is configured so as to limit driver assist provided before entering or when entering a crosswalk when the time period during which at least part of the crosswalk region ahead on an adjoining lane of a current lane in which the vehicle is running continues to be a blind spot of the surrounding sensor is less than a predetermined time period.

Further, according to another aspect of the present disclosure, there is provided a driver assist method by a driver assist control device of a vehicle provided with a surrounding sensor acquiring surrounding data showing at least the situation ahead of the vehicle, which method limits driver assist provided before entering or when entering a crosswalk when the time period during which at least part of the crosswalk region ahead on an adjoining lane of a current lane in which the vehicle is running continues to be a blind spot of the surrounding sensor is less than a predetermined time period.

Further, according to another aspect of the present disclosure, there is provided a nontransitory computer storage medium including a computer program for execution by a processor installed in a vehicle provided with a surrounding sensor configured to acquire surrounding data showing at least the situation ahead of the vehicle. The computer program makes the processor limit driver assist provided before entering or when entering a crosswalk when the time period during which at least part of the crosswalk region ahead on an adjoining lane of a current lane in which the vehicle is running continues to be a blind spot of the surrounding sensors is less than a predetermined time period.

Further, according to another aspect of the present disclosure, there is provided a vehicle provided with a surrounding sensor for acquiring surrounding data showing at least the situation ahead of the vehicle and a driver assist control device configured to provide driver assist of the vehicle. The driver assist control device is configured to limit driver assist provided before entering or when entering a crosswalk when the time period during which at least part of the crosswalk region ahead on an adjoining lane of a current lane in which the vehicle is running continues to be a blind spot of the surrounding sensor is less than a predetermined time period.

According to these aspects of the present disclosure, it is possible to provide suitable driver assist according to the surrounding environment when passing a crosswalk.

### BRIEF DESCRIPTION OF DRAWINGS

FIG. 1 is a schematic view of the configuration of a driver assist apparatus according to one embodiment of the present disclosure.

FIG. 2 is a bird's eye view showing by time sequence an example of a scenario where an adjoining lane is congested and a crosswalk region ahead on the adjoining lane is continuously hidden by other vehicles in the adjoining lane.

FIG. 3 is a schematic view showing the situation ahead viewed from the host vehicle of FIG. 2.

FIG. 4 is a bird's eye view showing by time sequence an example of a scenario where an adjoining lane is not congested and a crosswalk region ahead on the adjoining lane is temporarily hidden by other vehicles running in the adjoining lane.

FIG. 5 is a flow chart for explaining details of driver assist control performed by the control device.

### DESCRIPTION OF EMBODIMENTS

Below, referring to the drawings, embodiments of the present disclosure will be explained in detail. Note that, in the following explanation, similar components will be assigned the same reference notations.

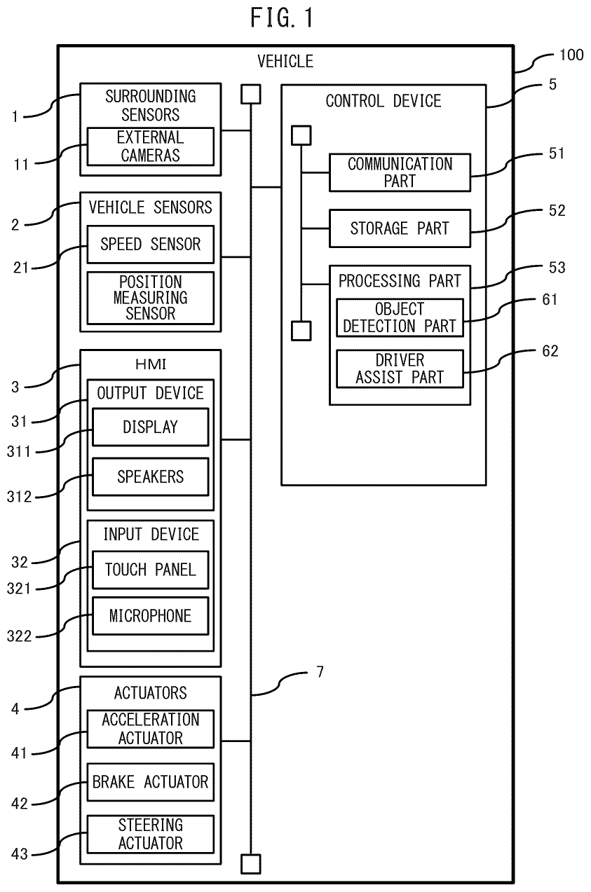

FIG. 1 is a schematic view of the configuration of a driver assist apparatus 100 according to one embodiment of the present disclosure.

The driver assist apparatus 100 is provided with surrounding sensors 1, vehicle sensors 2, an HMI (human machine interface) 3, actuators 4, and a control device (driver assist control device) 5. The surrounding sensors 1, vehicle sensors 2, HMI 3, actuators 4, and control device 5 are connected to be able to communicate through an internal vehicle network 7 based on the standard called the Control Area Network.

The surrounding sensors 1 are sensors for generating surrounding data showing the situation in the surroundings of the vehicle at which the driver assist apparatus 100 provides driver assist (below, referred to as the “host vehicle”). In the present embodiment, as the surrounding sensors 1, one or more external cameras 11 for capturing the surroundings of the host vehicle including at least the area ahead of the host vehicle are provided. The external cameras 11 capture the surroundings of the host vehicle by a predetermined frame rate (for example, 10 Hz to 40 Hz) and generate surrounding images in which the surroundings of the host vehicle are displayed. The external cameras 11 send the generated surrounding images as surrounding data to the control device 5 each time generating the surrounding images.

Note that instead of the external cameras 11 or in addition to the external cameras 11, it is also possible to provide as a surrounding sensor 1 a distance measuring sensor for measuring the distance to a vehicle, pedestrian, or other object present in the surroundings of the host vehicle. As an example of a distance measuring sensor, for example, a lidar (light detection and ranging device) firing a laser and measuring distance based its reflected light, a millimeter wave radar sensor measuring distance based on the reflected wave, etc. may be mentioned.

The vehicle sensors 2 are sensors for generating vehicle data showing the situation of the host vehicle. In the present embodiment, as the vehicle sensors 2, for example, a speed sensor 21 for generating speed data showing a running speed of the host vehicle and, for example, a position measurement sensor 22 for generating current position data showing the current position of the host vehicle such as the longitude and latitude etc. are provided. However, the vehicle sensors 2 are not limited to these sensors. The vehicle sensors 2 send the acquired data (for example, the speed data and current position data) as vehicle data to the control device 5.

The HMI 3 is a user interface for transfer of information between the host vehicle and its occupants. The HMI 3 is provided with output devices 31 for providing notifications to the vehicle occupants through the physical senses of the vehicle occupants (for example, sight, hearing, touch, etc.) and input devices 32 for the vehicle occupants to perform input operations and response operations. In the present embodiment, as output devices 31, a display (for example, meter display, center display, heads-up display, etc.) 311 and speakers 312 are provided. As the input devices 32, a touch panel 321 and microphone 322 are provided.

The HMI 3 displays information corresponding to a display signal received from the control device 5 (for example, text information or graphic information) on the display 311 and outputs audio corresponding to an audio signal from the speakers 312. Further, the HMI 3 sends data input by the touch panel or input by voice by the vehicle occupant through the input devices 32 (below, referred to as the “passenger input data”) to the control device 5.

The HMI 3 may be mounted in the host vehicle in advance or may be a smartphone or other terminal held by a vehicle occupant. In the latter case, for example, information may be transferred by short distance wireless between the host vehicle and terminal of the vehicle occupant, the terminal of the vehicle occupant and an outside server (not shown) may communicate with each other, and information may be transferred indirectly through the server.

The actuators 4 are devices used for controlling operations of the host vehicle. In the present embodiment, as the actuators 4, acceleration actuators 41 for controlling acceleration of the host vehicle (for example, at least one of the engine and motor), brake actuators 42 for controlling braking of the host vehicle (for example, a hydraulic actuator), and steering actuators 43 for controlling steering of the host vehicle (for example, a steering motor) are provided.

The control device 5 is an ECU (electronic control unit) provided with a communication part 51, storage part 52, and processing part 53.

The communication part 51 has a communicate interface circuit for connecting the control device 5 to the internal vehicle network 7. The communication part 51 supplies the various data received from the sensors 1 and 2, the HMI 3, etc. to the processing part 53. Further, the communication part 51 outputs the various signals output from the processing part 53 to the HMI 3, actuators 4, etc.

The storage part 52 has an HDD (hard disk drive), SSD (solid state drive), semiconductor memory, or other storage medium and stores various computer programs and data etc. used for processing at the processing part 53.

The processing part 53 has one or more CPUs (central processing units) and their peripheral circuits and runs various computer programs stored in the storage part 52. The processing part 53 is for examples a processor. The processor may further have other processing circuits such as a logical operation unit, numerical operation unit, or graphic processing unit. The processing part 53 performs processing in accordance with a computer program so as to function as an object detection part 61 and driver assist part 62 and operate as a function part (module) realizing a predetermined function. In the following explanation, if explaining the processing using the function parts 61 and 62 as subjects, the processing part 53 runs programs for realizing the function parts 61 and 62.

Below, the content of the specific processing performed at the control device 5 will be explained. That is, the content of the function parts 61, 62 realized by the processing part 53 performing processing in accordance with the programs will be explained.

The object detection part 61 detects an object based on the surrounding data received from the surrounding sensors 1. In the present embodiment, the object detection part 61 detects a crosswalk ahead and left and right lane dividing lines of the current lane based on surrounding images received from external cameras 11.

For example, the object detection part 61 can use pattern matching, semantic segmentation, or other image recognition techniques to detect a crosswalk ahead based on surrounding images received from the external cameras 11. Further, for example, the object detection part 61 can use edge detection, semantic segmentation, or other image recognition techniques to detect left and right dividing lines of a current lane based on surrounding images received from the external cameras 11.

Other than such a method as well, for example, the object detection part 61 inputs the surrounding images received from the external cameras 11 into a classifier pretrained so as to detect a crosswalk and lane dividing lines so as to be able to detect a crosswalk and lane dividing lines. The classifier, for example, can be made a convolutional neural network (CNN) having a plurality of convolutional layers connected in series from the input side to the output side. By inputting images including crosswalks and lane dividing lines in advance as teacher data and training by the same, the CNN operates as a classifier for detecting a crosswalk and lane dividing lines.

Further, the object detection part 61 detects crosswalk data relating to a crosswalk when detecting a crosswalk. The crosswalk data includes, for example, the distance to the crosswalk and the length Ld in the vehicle width direction of the crosswalk (below, referred to as the “crosswalk length”). The distance to the crosswalk can be detected, for example, based on the Y coordinate (vertical coordinate) distance on the surrounding image where the crosswalk is detected or the size of the crosswalk region extracted from the surrounding image by image recognition etc. The crosswalk length Ld can be detected, for example, based on the distance to the crosswalk, the size of the crosswalk region extracted from the surrounding image by image recognition, etc.

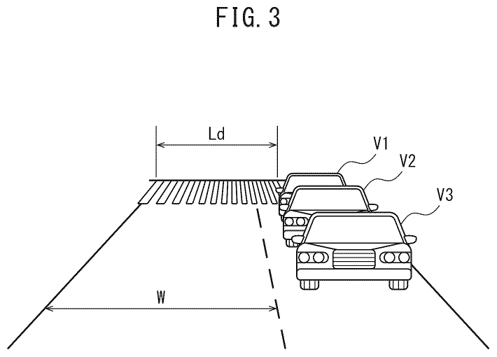

Note that, the crosswalk length Ld detected by the object detection part 61 is the length in the vehicle width direction of the crosswalk in the range actually displayed in the surrounding images (that is, the range able to be detected by the surrounding sensors 1). Therefore, as shown in the later explained FIG. 3, if part of the crosswalk is hidden by other vehicles on an adjoining lane, the crosswalk length Ld detected by the object detection part 61 becomes shorter than the total length L of the crosswalk.

Further, if detecting the left and right lane dividing lines of the current lane, the object detection part 61 detects the current lane data relating to the current lane. The current lane data, for example, includes the distance between the left and right lane dividing lines of the current lane, that is, the road width (width) W of the current lane. The road width W of the current lane can, for example, be detected based on the X coordinate (horizontal coordinate) distance between the lane dividing lines on the surrounding images detecting the left and right lane dividing lines of the current lane.

The driver assist part 62 judges, based on the results of detection of the object detection part 61, whether part of the region of the crosswalk ahead is hidden by other vehicles present before the crosswalk on the adjoining lane etc., that is, whether at least part of the region of the crosswalk ahead on the adjoining lane (below, referred to as a “crosswalk region ahead on the adjoining lane”) has become a blind spot region of the driver and surrounding sensors 1. The adjoining lane may be a lane with the same direction of advance as the host vehicle (slow lane, passing lane, right turn lane, left turn lane, etc.) or may be an oncoming lane.

Further, if a crosswalk region ahead on the adjoining lane has become a blind spot region, the driver assist part 62 cannot judge whether there is a pedestrian present in the region, so it provides driver assist to the driver. As driver assist to the driver, the driver assist part 62 can, for example, use the HMI 3 to notify the driver to draw his attention, notify the driver to prompt deceleration, or provide other notification. Further, as driver assist to the driver, in addition to or in place of notifications by the HMI 3, the driver assist part 62 can, for example, use actuators 4 to control running of the host vehicle (for example, stopping acceleration, deceleration, steering to avoid objects, etc.)

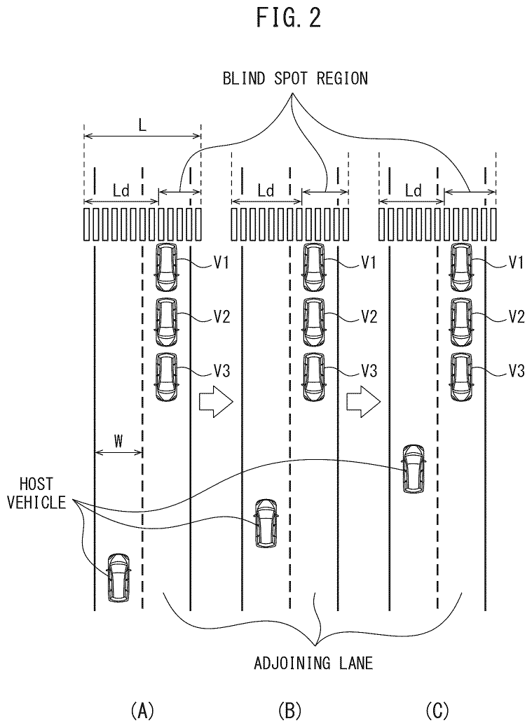

Below, referring to FIG. 2 to FIG. 5, the driver assist by the driver assist part 62 will be explained in further detail.

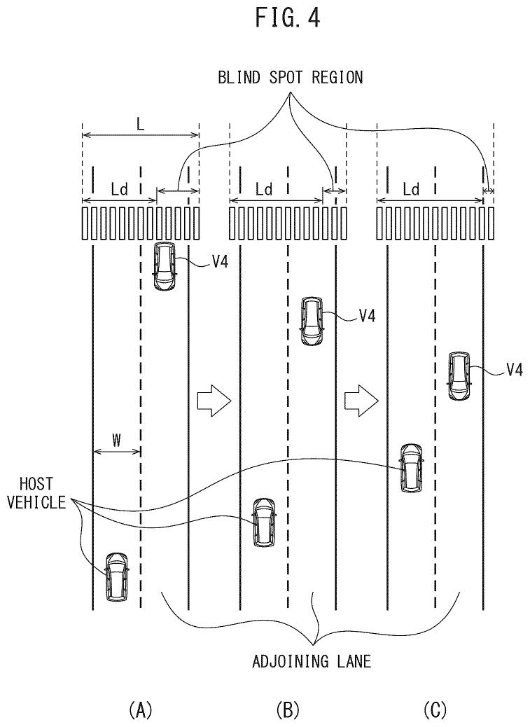

(A) to (C) of FIG. 2 are bird's eye views showing by time sequence one example of the scenario where an adjoining lane (in this example, an oncoming lane) is congested and a crosswalk region ahead on the adjoining lane is continuously hidden by other vehicles on the adjoining lane. FIG. 3 is a schematic view showing the situation ahead when viewed from the host vehicle of FIG. 2. On the other hand, (A) to (C) of FIG. 4 are bird's eye views showing by time sequence one example of the scenario where an adjoining lane (in this example, an oncoming lane) is not congested and a crosswalk region ahead on the adjoining lane is temporarily hidden by other vehicles on the adjoining lane.

As shown in FIG. 2 and FIG. 3, if congestion occurs at an adjoining lane or otherwise if other vehicles V1 to V3 of an adjoining lane stop or run by a slow speed before the crosswalk ahead of the host vehicle, the crosswalk region on the adjoining lane ends up being hidden by the other vehicles V1 to V3 until right before the host vehicle approaches the crosswalk and passes the crosswalk. Sometimes the region becomes a blind spot region. There is a possibility that the blind spot region will have pedestrians crossing the crosswalk etc. present. For this reason, if the crosswalk region on the adjoining lane becomes a blind spot region, it is preferable to perform driver assist at a suitable timing before the host vehicle passes the crosswalk.

On the other hand, as shown in FIG. 4, sometimes congestion does not occur on an adjoining lane and another vehicle V4 on the adjoining lane before the crosswalk ahead of the host vehicle is running by a normal running speed (for example, the legal speed). In such a case, for example, at the point of time of (A), the crosswalk region on the adjoining lane is hidden by the other vehicle V4 running on the adjoining lane and the crosswalk region on the adjoining lane temporarily becomes a blind spot region, but as shown in (B) and (C), along with the elapse of time, the other vehicle V4 moves away from the crosswalk, so the blind spot region is decreased.

In this way, sometimes the crosswalk on an adjoining lane becomes a blind spot region temporarily (or momentarily) while approaching the crosswalk, but if ending up performing driver assist until such a case, the driver is liable to feel driver assist is unnecessary or feel it is bothersome. Therefore, in the present embodiment, it is judged whether the crosswalk region on the adjoining lane has continuously become a blind spot region or whether the crosswalk region on the adjoining lane has temporarily become a blind spot region, then driver assist is provided.

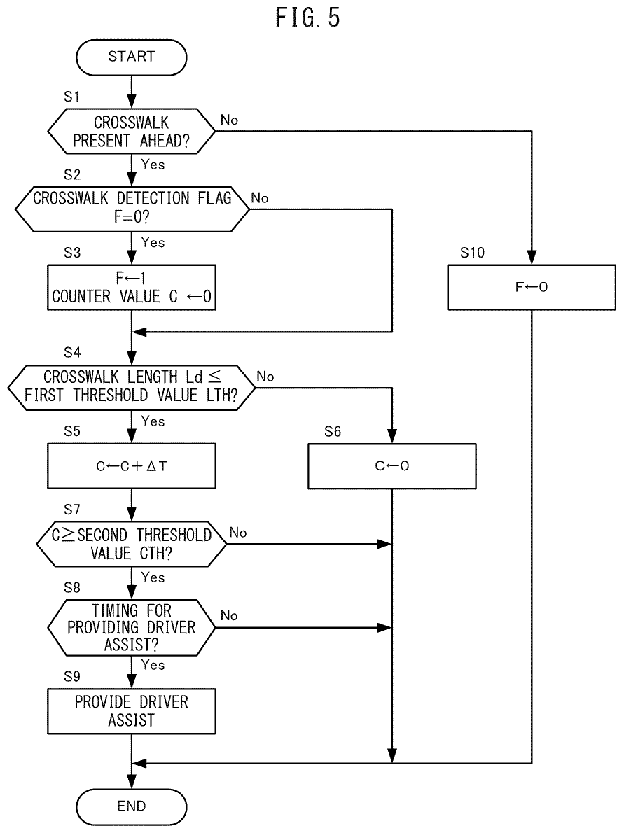

FIG. 5 is a flow chart for explaining details of the driver assist control according to the present embodiment which the driver assist part 62 and in turn the control device 5 performs. The control device 5 repeatedly performs the present routine at predetermined processing periods ΔT.

At step S1, the control device 5 judges if there is a crosswalk present ahead based on the results of detection of the object detection part 61. The control device 5 proceeds to the processing of step S2 if there is a crosswalk present ahead. On the other hand, the control device 5 proceeds to the processing of step S12 if there is no crosswalk present ahead.

At step S2, the control device 5 judges if a crosswalk detection flag F1 has been set to “0”. The crosswalk detection flag F1 is a flag set to “1” when newly detecting a crosswalk ahead. Its initial value is set to “0”. If the crosswalk detection flag F1 is set as “0”, the control device 5 judges that a crosswalk has been newly detected ahead by the current processing and proceeds to the processing of step S3. On the other hand, the control device 5 proceeds to the processing of step S4 if the crosswalk detection flag F1 is set to “1”.

At step S3, the control device 5 sets the crosswalk detection flag F1 to “1” and resets a counter value C to the initial value of 0. The counter value C is the value of a counter for measuring the time period during which a crosswalk region of an adjoining lane is continuously a blind spot region.

At step S4, the control device 5 judges if the crosswalk region ahead on the adjoining lane has become a blind spot region based on the results of detection of the object detection part 61. For example, the control device 5 can compare a crosswalk length Ld detected by the object detection part 61 with a later explained predetermined first threshold value LTH and judge that the crosswalk region ahead on the adjoining lane has become a blind spot region if the crosswalk length Ld is less than or equal to the first threshold value LTH. If the crosswalk length Ld is less than or equal to the first threshold value LTH, the control device 5 judges that the crosswalk region ahead on the adjoining lane has become a blind spot region and proceeds to the processing of step S5. On the other hand, if the crosswalk length Ld is greater than the first threshold value LTH, the control device 5 judges that the crosswalk region ahead on the adjoining lane has not become a blind spot region and proceeds to the processing of step S6.

The first threshold value LTH can be made a value set based on the road width W of the current lane detected by the object detection part 61, for example, a value of the road width W of the current lane multiplied with a predetermined value a (that is, LTH=W×α).

Specifically, the first threshold value LTH, for example, like in the example shown in the above-mentioned FIG. 2 and FIG. 3, can be made a value smaller than two lanes worth of road width set based on the road width W of the current lane if there is only an adjoining lane at one side of the current lane. This is because, for example, like in the example shown in the above-mentioned FIG. 2 and FIG. 3, if there is only an adjoining lane at one side of the current lane and the crosswalk region on the adjoining lane has become a blind spot region, the crosswalk length Ld becomes shorter than the two lanes worth of road width including the current lane and adjoining lane. Further, the first threshold value LTH can be made a value smaller than three lanes worth of road width set based on the road width W of the current lane if for example there are adjoining lanes at both the left and right sides of the current lane (the two adjoining lanes at the left and right may be the same in direction of progression of the host vehicle or one may be oncoming lanes).

At step S5, the control device 5 adds the processing period ΔT to the counter value C.

At step S6, the control device 5 resets the counter value C to the initial value of “0”.

At step S7, the control device 5 judges whether the crosswalk region ahead on the adjoining lane has continuously become a blind spot region. For example, the control device 5 can judge that the crosswalk region ahead on the adjoining lane has continuously become a blind spot region if the counter value C is greater than or equal to a predetermined second threshold value CTH set in advance by experiments etc. The second threshold value CTH is a threshold value for judging whether the crosswalk region ahead on the adjoining lane has continuously become a blind spot region. In the present embodiment, it is set to a time period of an extent by which it can be judged that an adjoining lane is congested, that is, a time period of an extent by which it can be judged that a crosswalk region ahead on the adjoining lane is hidden by other vehicles on the adjoining lane at a stop or running by a slow speed. For example, the second threshold value CTH can be set to any value in the range of a few seconds, but naturally it is not limited to within such a range.

If the counter value C is greater than or equal to the second threshold value CTH, the control device 5 judges that the crosswalk region on the adjoining lane has continuously become a blind spot region and proceeds to the processing of step S10. On the other hand, if the counter value C is less than the second threshold value CTH, the control device 5 judges that there is the possibility that the crosswalk region on the adjoining lane has temporarily become a blind spot region and ends the current processing.

At step S8, the control device 5 judges whether it is the timing for performing driver assist. The control device 5 can judge the timing for performing driver assist based on, for example, the distance to the crosswalk or the time of arrival. If the timing for performing driver assist, the control device 5 proceeds to the processing of step S9. On the other hand, if not the timing for performing driver assist, the control device 5 ends the current processing.

At step S9, the control device 5 performs driver assist for the driver. In the present embodiment, the control device 5 uses the HMI 3 to send the driver a notification for drawing his attention, a notification for prompting deceleration, or other notifications. However, as explained above, the content of the driver assist is not limited to such a content.

At step S10, the control device 5 resets the crosswalk detection flag F1 to the initial value of “0”.

According to the present embodiment explained above, there is provided a control device 5 (driver assist control device) provided with a surrounding sensor 1 for acquiring surrounding data showing at least the situation ahead of the vehicle, which device is configured so as to limit the driver assist before entering or when entering a crosswalk when the time period during which at least part of the crosswalk ahead on an adjoining lane of the current lane on which the vehicle is running continues to be a blind spot of the surrounding sensor 1 is less than a second threshold value CTH (predetermined time period).

Due to this, when the time period during which at least part of the crosswalk ahead on an adjoining lane of the current lane on which the vehicle is running continues to be a blind spot of the surrounding sensor 1 is less than the second threshold value CTH, that is, when the host vehicle is approaching the crosswalk and temporarily (or momentarily) the crosswalk region on the adjoining lane becomes a blind spot region, it is possible to keep driver assist from ending up being performed before entering or when entering the crosswalk.

On the other hand, when the time period during which at least part of the crosswalk ahead on an adjoining lane of the current lane on which the vehicle is running continues to be a blind spot of the surrounding sensors 1 is greater than or equal to the second threshold value CTH, that is, when the host vehicle is approaching the crosswalk and the crosswalk region on the adjoining lane becomes a blind spot region continuously due to congestion etc., it is possible to perform driver assist before entering or when entering the crosswalk.

For this reason, when passing a crosswalk, it is possible to perform suitable driver assist corresponding to the surrounding environment.

Note that, the driver assist performed before entering or when entering a crosswalk includes, for example, notifications to the occupants of the vehicle, control for stopping acceleration of the vehicle, control for decelerating the vehicle, control for steering the vehicle, etc. The second threshold value CTH can, for example, be set to a time period enabling judgment that an adjoining lane of the current lane is congested. Further, the second threshold value CTH can be set to a time period enabling judgment that at least part of the crosswalk ahead on an adjoining lane of the current lane is hidden by other vehicles on an adjoining lane of the current lane which are stopped or running by a slow speed.

Further, according to the present embodiment, there is provided a control device 5 (driver assist control device) configured to detect a crosswalk length Ld in the range detected by the surrounding data and the road width W of the current lane based on the surrounding data and judge that at least part of the crosswalk ahead on an adjoining lane of the current lane has become a dead spot of a surrounding sensor 1 when the crosswalk length Ld is less than or equal to a first threshold value LTH (predetermined threshold value) set based on the road width W of the current lane. The first threshold value LTH can, for example, be set to a value smaller than the road width including the current lane and adjoining lane.

Due to this, it is possible to judge that at least part of the crosswalk ahead on an adjoining lane of the current lane has become a blind spot by a simple method without detecting other vehicles etc. of the adjoining lane.

Above, embodiments of the present disclosure were explained, but the embodiments only show some of the applications of the present disclosure and are not meant to limit the technical scope of the present disclosure to the specific configurations of the embodiments.

For example, in the above embodiments, it is also possible to use the object detection part 61 to detect a traffic light and proceed to the processing of step S2 only when there is a crosswalk with no traffic light ahead at step S1 of FIG. 5.

Further, in the above embodiments, the computer programs run at the control device 5 (for example, drive assist control) may be provided in a form recorded at a computer readable portable recording medium such as a semiconductor memory, magnetic recording medium, or optical recording medium.

1. A driver assist control device of a vehicle provided with a surrounding sensor configured to acquire surrounding data showing at least the situation ahead of the vehicle, wherein
the driver assist control device is configured to limit driver assist provided before entering or when entering a crosswalk when the time period during which at least part of the crosswalk region ahead on an adjoining lane of a current lane in which the vehicle is running continues to be a blind spot of the surrounding sensor is less than a predetermined time period.

2. The driver assist control device according to claim 1, further configured to:
detect a length of the crosswalk in the range detected by the surrounding data and the road width of the current lane based on the surrounding data; and
judge that at least part of the crosswalk ahead on the adjoining lane of the current land has become a blind spot of the surrounding sensor when the length of the crosswalk is less than or equal to a predetermined threshold value set based on the road width of the current lane.

3. The driver assist control device according to claim 2, wherein
the predetermined threshold value is set to a smaller value than the road width including the current lane and the adjoining lane of the current lane.

4. The driver assist control device according to claim 1, wherein
the predetermined time is set to a time period enabling judgment that an adjoining lane of the current lane is congested.

5. The driver assist control device according to claim 1, wherein
the predetermined time is set to a time period enabling judgment that at least part of the crosswalk ahead on an adjoining lane of the current lane is hidden by other vehicles on the adjoining lane of the current lane which have stopped or are running at a slow speed.

6. The driver assist control device according to claim 1, wherein
the driver assist performed before entering or when entering a crosswalk includes notifications to occupants of the vehicle, control for stopping acceleration of the vehicle, control for decelerating the vehicle, or control for steering the vehicle.

7. A driver assist method by the driver assist control device of a vehicle provided with a surrounding sensor acquiring surrounding data showing at least a situation ahead of the vehicle, wherein
the driver assist method includes limiting driver assist provided before entering or when entering a crosswalk when the time period during which at least part of the crosswalk region ahead on an adjoining lane of a current lane in which the vehicle is running continues to be a blind spot of the surrounding sensor is less than a predetermined time period.

8. A nontransitory computer storage medium including a computer program for execution by a processor installed in a vehicle provided with a surrounding sensor configured to acquire surrounding data showing at least the situation ahead of the vehicle, wherein
the computer program makes the processor limit driver assist provided before entering or when entering a crosswalk when the time period during which at least part of the crosswalk region ahead on an adjoining lane of a current lane in which the vehicle is running continues to be a blind spot of the surrounding sensors is less than a predetermined time period.
